(19) United States
(12) Patent Application Publication
(10) Pub. No.: US 2014/0292488 A1
(43) Pub. Date: Oct. 2, 2014

(54) InSight

(71) Applicant: Jerome Joseph Trohak, Saskatoon (CA)

(72) Inventor: Jerome Joseph Trohak, Saskatoon (CA)

(21) Appl. No.: 13/853,062

(22) Filed: Mar. 29, 2013

(51) Int. Cl. G06K 7/10

(52) U.S. Cl. CPC G06K 7/10366
USPC 340/10.1; 29/601

(57) ABSTRACT

This green invention embodies a matched set of RF coded electronic handheld devices that provide an absolute self-sufficient unencumbered method of locating a loved one, a friend, or personal possessions. This invention encompasses a way to free ourselves from the unending dependence upon the cell phone. A simple product will evolve from this invention that will become a convenient method, tool, contrivance employed by everyone to make our lives freer happier and more rewarding. In our present time of active living, this welcome device saves quality time. Furthermore, this device saves on the generation of electricity. What makes this green device environmentally friendly is the fact that it provides an easy way to locate a person without utilizing any of the power generation required to supply energy to worldwide telecommunications.

### BACKGROUND OF THE INVENTION

This novel invention provides a completely novel idea, upgrade, and simple solution to locating a person, an animal, and or possessions. This invention effectively eliminates numerous problems arising from annoying situations where a person may waste much time not knowing the whereabouts of loved ones, friends, pets, people, and possessions. In a simple manner, this completely unique method allows a person to easily locate other people and possessions by utilizing a simple-to-operate electronics handheld device. This present invention is designed to find out-of-sight persons, pets, and possessions in a way that saves time and alleviates stress, worry, inconvenience, and heart ache. This invention is a vast improvement on all previous designs. This green invention is cost effective and would help to reduce the environmental costs associated with electric power generation for telecommunications.

Facts about global telecommunications energy consumption: Six billion cell phones are used worldwide.

http://en.wikipedia.org/wiki/List_of_countries_by_number_of_mobile_phones_i n_use
Yearly global energy consumption of mobile phones in 2011 was 107 million Megawatt hours.
http://www.cs.wichita.edu/˜vnambood/mypubs/LGEPavel2011.pdf

Cellular Telecommunications Industry Association CTIA says Americans collectively spent 2.321 trillion minutes on the phone over the last year. The problems of energy usage are addressed in a tiny way.

### BRIEF DESCRIPTION OF THE DRAWINGS

FIG. 1 shows a person using the device.

FIG. 2 shows one set of two corresponding devices.

FIG. 3 a device in the hand of a user.

FIG. 4 shows a view of one set of two corresponding devices in action.

FIG. 5 shows the light is illuminated on a device in the hand of Person A; indicating that the device has located Person B.

FIG. 6 shows a device attached to Person B.

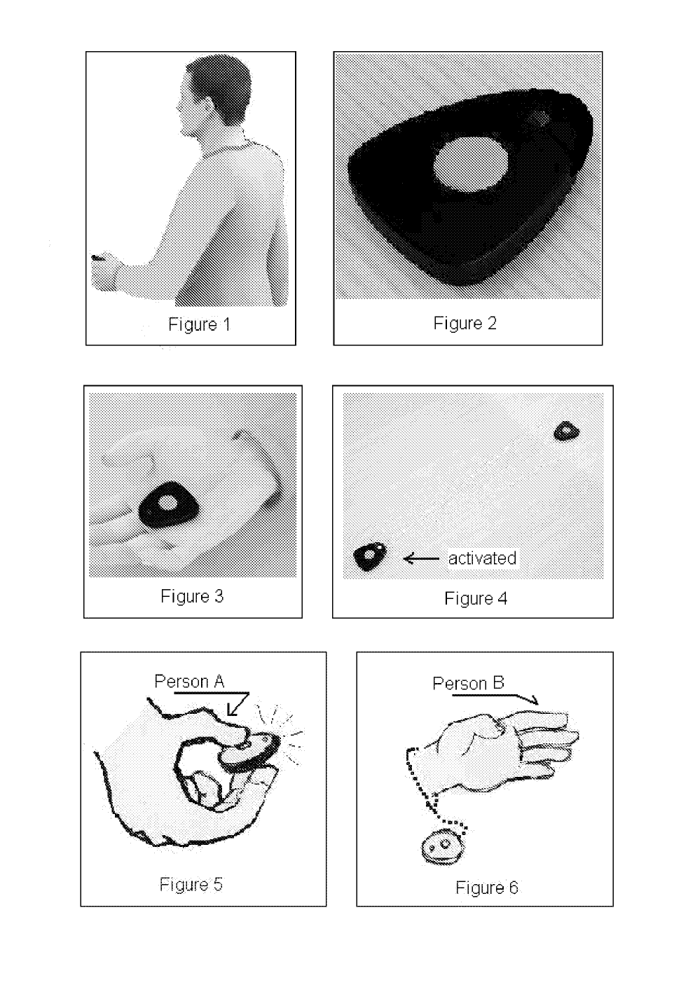

### DETAILED DESCRIPTION OF THE INVENTION

The encompassing objective of the present invention is to provide a convenient, quick, and pay-free method of location people, animals, and possessions by utilizing an easy-to-use matched set of pre-programmed coded radio frequency identification (RFID) tag transmitting/receiving devices. The present invention is a means by which a coded RF signal is radiated from a directional antenna on the sender device to a matched receiver device. The receiver device then relays this same coded signal back to the sender device. The returned signal then triggers the electronic circuitry to activate a light or sensory indicator on the sender device. Also, the found (receiver) device could optionally activate a sensory indicator locally. This response could notify and/or reassure the found person that someone is looking for them. The found person might reply with a return ‘tap.’ This ‘tap’ could be a button press.

The directional antenna comprises two parts: ¹a metal shield over²a printed circuit traces (antenna) on the substrate. The exact design of the directional antenna may vary upon manufacturing.

The electronic circuit design, of each device, contains few discrete components. Each device contains one directional antenna used solely for the transmission of coded RF waves. Each device contains one omni-directional antenna on board an RF module that is soldered to the substrate for the purpose of receiving (from all directions) a coded RF signal from the other device. In addition, each device contains one omnidirectional antenna in the form of a PC copper trace for the purpose of transmitting a coded RF signal in all directions.

An RF signal sent from any device in the matched set will wake up the other found device from a dormant state when the signal is directed in the correct direction. Each device may incorporate up to three buttons that may be pressed in any combination to provide up to seven different functions. These seven different functions may become useful for the disabled or for adapting the invention to special circumstances. This method, of locating each corresponding matched coded device, is infallible and secure.

The devices utilize the benefits of code hopping technology. Each code hopping RF transmission is unique. The application of code hopping technology ensures that the set of devices can operate impervious to mischievous or covert activity. Code scanners have no effect on the security of any given set of devices. Code scanning s counteracted by increasing the number of code combinations. A 66-bit code will yield 7.3×10 combinations and take 230 billion years to scan. The code grabber must predict ahead of time code of the next transmission.

Any device, in the set of two or more devices, can be used to locate any other device. The device that has its button pushed will be known as the seek device, simply because it is the device being used to seek the other “found” device.

A user presses a button on the seek device and then points it in all directions in order to sweep the surrounding area (above below and to the sides) in order to locate the other found device—in the same way that a flashlight turned on would reveal the person or object of a search in the dark. While the seek device is activated by a button press; it waits for a response in the form of a coded signal to be sent from the found device When the seek device is activated by a button press and pointed at the found device; the found device receives this coded signal. If the RF signal from the seek device is recognized by the found device; the electronic circuitry in the found device may or may not switch on a light or sensory indicator. The activation of a sensory indicator in the found device is optional.

The found device immediately transmits a separate coded RF signal in all directions. The seek device will receive, and read, this coded RF signal that was transmitted from the found device. If the RF signal from the found device is recognized by the seek device; the electronic circuitry in the seek device will switch on a light or sensory indicator in the seek device. The activation of a light or sensory indicator in the seek device is compulsory.

The in-coming and out-going RF transport codes are separate to prevent false triggering of the LED on the seek device.

When the light or sensory indicator is activated on the seek device, the direction in which the seek device is pointed, within the angle of radiation, points in the direction of the found device. The light on the seek device will illuminate when the units are within a specified distance (range) from one other. If the button on the seek device s pressed and then the seek device is pointed away for the found device the light on the seek device will go out.

The light on the seek device could be designed so that it blinks faster as the two devices get closer to each other. The seek device could have e row of lights or a series of multiple indicators. But a user may find it well enough that a single light indicate the direction of the found device. Any sensory indicator could be designed in any number of different ways. This invention encompasses all the possible different applications, known and unknown, that will be imagined and derived from the design, development, and practical use of the ensuing, evolutionary set of products. All such applications remain the property of the inventor: Jerome Trohak.

The ‘behaviour’ of the electronic circuits, as shown in the electronic schematics, is stable. The circuit design is functional.

The transmitted RF signal, sent from the any device in the set, is confined by an angle of radiation inherent to the directional antenna. In practice, this angle should be approximately 390 degrees. The transmitted RF power is concentrated within the confines of the angle of radiation contributing to the gain of the antenna. The narrower that angle of radiation the greater is the gain of the antenna; and the greater the range of the transmitted RF signal. The accuracy of any device depends upon the directivity of the antenna.

The design of the electronic circuitry is maximized for RF receiver sensitivity to utilize the best range within the allowable power levels governed by the FCC guidelines. In practical applications, there is a balance between the FCC guidelines and an attainable desired range.

The design of the code hopping integrated circuit incorporated in this invention allows the device to be adapted to all uses. The code hopping integrated circuit is programmed to transmit “one in four” coded signals. The circuit continues to remain fully functional. The peak to peak (P2P) power of each of “one in four” coded RF square wave transmissions has been increased four fold thereby increasing the range and yet the signal strength remains within the FCC guidelines. Code hopping science has shown that the effective isotropic radiated power (EIRP) remains constant from continuous “one in four” RF square wave transmission; although the P2P power was increased four fold on each of “one in four” square wave RF transmissions.

Factors governing range include:
Antenna (gain, human body model)
Low noise
Sensitivity
Output power
RF pollution (selectivity, blocking, IP3)
Environment (obstructions, reflections, multipath fading, weather, rain mist, sunshine)

Each device contains encoder and decoder circuitry and thereby inherits all the options and features that are incorporated within each encoder integrated circuit and within each decoder integrated circuit attached to the PCB. The code hopping integrated circuits are designed to prevent RF signal collisions.

The code hopping integrated circuits contain an automatic shut-off feature. The shut-off function automatically stops the device from transmitting, if a button gets inadvertently pressed for a long period of time. This will prevent the device from draining the battery, if a button gets pressed while the device is in a pocket or purse. The integrated circuit will stop transmitting, if the button is pressed for longer than 20 seconds. The device will remain in this deactivated state indefinitely. The device will return immediately to an active state once the button is released.

The advantages of the code hopping technology have bee adapted to the circuit design in such a way as to allow for uninterrupted use. The deactivated state of one device has not effect upon its ability to continue to function as an RF reflector for the other device. In the event that a button on one of the devices becomes stuck (i.e.: because it is jammed inside a pocket or purse) then it will stop transmitting to preserve battery energy. But the jammed device will continue to be able to respond in a normal way to a signal that is sent from the other device. When the jammed device is removed from the pocket or purse then it can be used immediately.

Any set of devices could be utilised to find directions to a deserted location in a simple way that supersedes triangulation and Global Positioning System (GPS.) The design of InSight could be adapted to GPS and space travel (theory.) The design of InSight could be adapted to Braille.

InSight will not interfere with any other similar units or any other telecommunicated electromagnetic signal. The foregoing encompassing descriptions point out to the industry the viability of the present invention. These depictions are not intended to be exhaustive or to limit the applications, upgrades, the development of other products, or to limit the development of any product to the precise forms disclosed. Manu modifications and variations are possible in the light of the above disclosure.

The foregoing information serves as a model, or pattern. It was described to best explain the principles of an improved product. Its practical applications will be determined by skilled professionals, who are adept in the art of Design and Development. They may contemplate and best utilize the resources and with various modifications present this product to the market.

This present invention provides users with an easy way to locate a loved one, possessions, or family pet(s) by utilizing two, or more, corresponding devices. This unique invention would benefit deaf people, the disabled, hunters, livestock management, spots, enthusiasts, caregivers, the police, security, as well as other people who want to keep tabs on family members, friends, possessions, or animals.

Doctors, who utilize these devices to locate patients, can confidently perform their duties in complete privacy. These devices can be used to provide protection for the vulnerable and weak members of the community. This device can provide all hospitals, institutions, caregivers, and clergy with a way to keep track of patients, inmates, needful, and shut-ins.

This device could be used as a homing device. Police and law enforcement officials could utilize these devices as security tools in the performance of their duties. Quietly, hunters could locate each member of the hunting expedition to avoid injuring anyone. Sports enthusiasts could track participants, locate buried humans, locate members of a team, and generally provide a safe playing community. The leaders of a group could locate everyone on a field trip or outing.

A set of devices could provide an advanced, alternate, additional, way for automotive, truck, and machinery dealerships to keep (RFID) tag track of their stock and to trace stolen, or missing, vehicles or machinery.

The army could utilize the devices to aid in additional security and stealth enforcement tools. While the troops are walking away from camp or battle they could find their way undetected to a predetermined locale in the desert or safe locale by utilizing this coded tool. Stealth tool: the army could plant something then avoid that area. Without risking lives the army could move about and locate other detachments while remaining undetected thereby avoiding danger. The device is incorporated with code hopping technology which ensures security. Soldiers could avoid planted land mines.

The adroit manufacturer will get a head start in the initial stages of a product that has no competition. The circuit could be further adapted to make use of the continued upgrades, developments, and designs which are so much part of the electronic industry. The present invention could be designed to make continued use of the evolution of the science. The matched set of coded RF transmitting/receiving devices could be continually upgraded to provide an evolutionary series of products that will encompass the changing trends, applications, and choices available.

### BRIEF DESCRIPTION OF THE INVENTION

This invention is a completely new approach to a pioneering idea. A unique adaptation of code hopping technology, combined with Radio frequency (RFID) tag, enable the user to easily locate each device in the matched set. The method, by which the RF circuitry in each device is adapted to the code hopping technology, is unique. When a family, or a group of people, visits a crowded public place; such as a shopping mall, park, or outdoor recreation area, keeping track of everyone may be a challenge. Much time and energy may be wasted looking for loved ones or members of a group or team, when they are out of sight. Likewise; when a family pet goes missing, owners may have no idea where to begin looking and the search could be tedious.

InSight provides cost-free usage. Here is a simple, stress-free, and handy way to locate someone, while avoiding annoyances and the subjection of the out-of-sight person to a hazardous or inconvenient interruption. The other person could be busy at some task and not able to answer a paid mobile phone call. No need to take a risk. No longer is it necessary to push the tiny buttons on the key pad of a telecommunications device. The consumer only needs to push one button and with casual arm motion affect the desired result of finding the other person.

1-16. (canceled)

17. A matched set of RF coded electronic devices comprising: locating matched devices, and directly locating the matched set with a coded RF signal radiating from a directional antenna suitably positioned on a sender device to a matched receiver device, the receiver device relaying a separate RF coded signal back to the sender device preventing false triggering of a light or sensory indicator on any device, having a returned signal triggering the electronic circuitry to activate a light or sensory indicator on the sender device, wherein each device of the matched set contains an omni-directional antenna, an on-board a long-range RF amplifier module that is soldered to the substrate for receiving from all directions a coded RF signal, having a unique RF coded hopping transmission from any device, wherein the application of coded hopping technology is secure, and the hopping coded signal changes every time a button is pushed on any device to initiate a search for a found device, wherein a code hopping integrated circuit is programmed to transmit one in four coded signals, wherein the code hopping integrated circuits are designed to prevent RF signal collisions, wherein the code hopping integrated circuits contain an automatic shut-off feature, and the shut-off function automatically stops the device from transmitting, wherein the integrated circuit stop transmitting, if the button is pressed for longer than 20 seconds, wherein the RF signal from the sender device could trigger a light or sensory indicator on the found device, wherein the triggered sender device points in the direction of the found device, wherein each device contains one directional antenna used solely for the transmission of coded RF waves, wherein an RF signal sent from any sender device in the matched set wakes up any found device from a dormant state when the signal is appropriately directed at the found device, wherein a unique adaptation of code hopping technology, combined with Radio frequency (RFID) tag, enables the user to easily locate any device in the matched set, wherein an increase in RF power transmission to increase the range complies with FCC regulations, wherein code hopping process indicate that the effective isotropic radiated power (EIRP) remains constant , wherein the peak to peak (P2P) power is increased four-fold on each of “one in four” square wave transmissions, wherein any device will not interfere with any RF signal, wherein any two matched devices can locate each other at the same time, and if a button gets inadvertently pressed for a long period of time, wherein the shut-off process prevents the device from draining the battery, if a button gets pressed while the device is in a pocket or purse, wherein the device will remain in deactivated state indefinitely and the device will return immediately to an active state once the button is released, wherein a matched jammed device does not interfere with the functionality of a matched sender device, wherein the jammed device will continue to respond to an RF coded wave flowing from a matched sender device, thereby allowing the sender device to locate the jammed device, wherein the electronic circuit on the substrate is configured to provide seven independent functions, wherein the needs of the handicapped and disabled, or special circumstances, can be addressed with these seven functions, wherein the matched devices can be adapted to all situations requiring the safe, secure, and timely location of persons and possessions.
